(19) United States
(12) Patent Application Publication
(10) Pub. No.: US 2021/0012065 A1
(43) Pub. Date: Jan. 14, 2021

(54) Methods Circuits Devices Systems and Functionally Associated Machine Executable Code for Generating a Scene Guidance Instruction

(71) Applicant: Yaniv Shmuel, Tel Aviv (IL)

(72) Inventor: Yaniv Shmuel, Tel Aviv (IL)

(21) Appl. No.: 16/946,973

(22) Filed: Jul. 14, 2020

Related U.S. Application Data
(60) Provisional application No. 62/873,920, filed on Jul. 14, 2019.

(51) Int. Cl. G06F 40/279; G06N 20/00; G06Q 30/02; G06F 40/30

(52) U.S. Cl. CPC G06F 40/279; G06F 40/30; G06Q 30/0201; G06N 20/00

(57) ABSTRACT

Disclosed are methods, circuits, devices, systems and functionally associated machine executable code for generating a scene interaction guidance instruction. One or more sensors directed towards an area of the interaction capture information about messages generated by an agent and a subject participants, wherein the captured messages can be verbal or visual in format. A computing platform receives and processes the captured information using a computerized message interpreter to extract meaning from the captured messages information; and a message impact assessment module to characterize, based on the extracted meaning, an impact of each agent generated message on the subject, wherein each impact characterization indicates whether a respective message brought the interaction closer to, or further away from, the specific objective.

### RELATED APPLICATIONS SECTION

The present application claims priority from U.S. Provisional Patent Application No. 62/873,920, filed Jul. 14, 2019, which application is hereby incorporated by reference in its entirety.

### FIELD OF THE INVENTION

The present invention generally relates to the field of scene monitoring and analysis. More specifically, the present invention relates to methods, circuits, devices, systems and functionally associated machine executable code for generating a scene guidance instruction.

### BACKGROUND

Communication channels between companies and customers, such as website, phone and other electronic messaging tools are being analyzed. However, companies and organizations are currently blind to insights from face to face interactions between reps and customers.

There remains a need, in the field of scene monitoring and analysis, for solutions to monitor face to face participants' interactions within a monitored scene and to provide participant guidance instructions improving chances of achieving scene goals/targets/objectives such as better sales effectiveness, customer experience and rep evaluation.

### SUMMARY OF THE INVENTION

Embodiments of the present invention may include methods, circuits, devices, systems and functionally associated machine executable code to monitor and derive insights from an interaction between two or more participants within a live scene of a given scene type.

Further embodiments of the present invention may include methods, circuits, devices, systems and functionally associated machine executable code to generate one or more scene guidance instructions, either for the scene being monitored or for future scenes of the given scene type.

A scene guidance instruction according to embodiments of the present invention may: (a) be provided to one or more scene participants, (b) trigger an external intervention in the scene being monitored, (c) generate an entry or record to be included in a report relating to the monitored scene, and (d) generate a recommendation to be used for improving interactions in future scenes of the given scene type.

A scene monitoring and guidance system, according to embodiments of the present invention, may be integral or otherwise connected to one or more (scene) sensors directed towards a scene of interest, such as at a scene, venue, or location where an interaction or meeting of interest is or will take place. An interaction or meeting of interest according to embodiments, may be classified as being of a specific interaction/meeting type, such as for example a “sales” type of interaction, a “service request” type of interaction or a “complaint resolution” type of interaction, just to name of few types. A scene where specific interaction types are staged, organized or otherwise occur may be referred to as scenes of a specific scene type, such as for example a “sales” type scene, a “service request” type scene and or a “complaint” type of scene.

Sensor outputs may be monitored and or analyzed for purposes of detecting messages and or message responses within interactions between scene participants in a monitored scene. Message detection and classification may be at least partially based on processing and analysis of the sensor outputs using message detection parameters within a scene type configuration script for the given scene type. Response detection and classification may be at least partially based on processing of the sensor outputs using response detection parameters within a scene type configuration script for the given scene type.

A given scene/interaction, according to embodiments, may be further associated with, or its interaction script may include, an interaction objection. A first interaction participant message may be assessed—for its impact on a second participant—at least partially based on an analysis of the second participant response message, and/or his behavioral response, to that message. Second participant responses' indications of advancement towards, or away from, the objective, may be used to characterize the impact of the first participant message.

Embodiments of the present invention may further include participant interface/notification/intervention devices or appliances which signal or otherwise convey a scene guidance instruction to one or more scene participants. Scene guidance instructions may be real-time and may be conveyed to one or more scene participants in response to either a static trigger or to a dynamic trigger. An example of a static trigger may be the passing of a specific duration of time since an interaction started. An example of a dynamic trigger may be the detection of specific messages and/or specific responses exchanged during an interaction.

A computerized system operating in accordance with embodiments of the present invention may generate one or more scene guidance instructions automatically, in response to a detection of a specific condition of an interaction within a scene of a given scene type. The condition may be at least partially associated with specific content or messages exchanged between two or more people in the scene. The condition may be at least partially with specific responses to content or messages exchanged between two or more participants in the scene. The detected message or response relating to the condition may be verbal, non-verbal, physical, biometric, etc. The detected condition may also relate to environmental conditions within and otherwise related to the monitored scene.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings:

FIG. 1, is a block diagram of an exemplary system for generating a scene guidance instruction, in accordance with some embodiments of the present invention, wherein main system components and interrelations there between are shown;

FIG. 2, is a flowchart showing the main steps executed as part of an exemplary process for generating a scene guidance instruction, in accordance with some embodiments of the present invention;

FIG. 3, is a block diagram of an exemplary system for generating a scene guidance instruction, in accordance with some embodiments of the present invention, wherein data input, processing, analysis and output components of the system and data flow there between are shown;

FIG. 4A, is a flowchart showing the main steps executed as part of an exemplary process for generating instructions based on a guest response, in accordance with some embodiments of the present invention;

FIG. 4B, is a flowchart showing the main steps executed as part of an exemplary process for generating an alert on deviation from a monitored scene or meeting script, in accordance with some embodiments of the present invention;

FIG. 4C, is a flowchart showing the main steps executed as part of an exemplary process for generating responses to session respond-able events, in accordance with some embodiments of the present invention;

FIG. 4D, is a flowchart showing the main steps executed as part of an exemplary process for cue management, in accordance with some embodiments of the present invention;

FIG. 4E, is a flowchart showing the main steps executed as part of an exemplary process for initiating an automatic call to guest participant in a monitored scene meeting or interaction, in accordance with some embodiments of the present invention; and

FIG. 5, is a schematic layout showing the main components and data/signals flows of an exemplary mutual recording configuration/scheme of a system in accordance with some embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals or element labeling may be repeated among the figures to indicate corresponding or analogous elements.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer, computing system, computerized mobile device, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device, for example a computerized device running a web-browser.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid state memory, magnetic tape, a removable computer diskette, a random access memory (RAM), a read-only memory (ROM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution. The memory elements may, for example, at least partially include memory/registration elements on the user device itself.

In some embodiments, input/output or I/O devices (including but not limited to keyboards, displays, pointing devices, etc.) may be coupled to the system either directly or through intervening I/O controllers. In some embodiments, network adapters may be coupled to the system to enable the data processing system to become coupled to other data processing systems or remote printers or storage devices, for example, through intervening private or public networks. In some embodiments, modems, cable modems and Ethernet cards are demonstrative examples of types of network adapters. Other suitable components may be used.

Functions, operations, components and/or features described herein with reference to one or more embodiments, may be combined with, or may be utilized in combination with, one or more other functions, operations, components and/or features described herein with reference to one or more other embodiments.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “includes”, “including”, “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

The present disclosure is to be considered as an exemplification of the invention, and is not intended to limit the invention to the specific embodiments illustrated by the figures or description below.

The following publications include teachings of computer-vision based face analysis techniques whose teachings are hereby incorporated by reference in their entirety:
Ahonen T, Hadid A & Pietikäinen M (2004) Face recognition with local binary patterns. In: Computer Vision, ECCV 2004 Proceedings, Lecture Notes in Computer Science 3021, 469-481.
Määttä J, Hadid A & Pietikäinen M (2012) Face spoofing detection from single images using texture and local shape analysis. IET Biometrics 1(1):3-10.
Zhao G & Pietikäinen M (2007) Dynamic texture recognition using local binary patterns with an application to facial expressions. IEEE Transactions on Pattern Analysis and Machine Intelligence 29(6):915-928.
Guo Y, Zhao G & Pietikäinen M (2016) Dynamic facial expression recognition with atlas construction and sparse representation. IEEE Transactions on Image Processing 25(5):1977-1992.
Pfister T, Li X, Zhao G & Pietikäinen M (2011) Recognizing spontaneous facial micro-expressions. Proc. International Conference on Computer Vision (ICCV 2011), Barcelona, Spain, 1449-1456.
Li X, Chen J, Zhao G, & Pietikainen, M (2014) Remote heart rate measurement from face videos under realistic situations. Proc. IEEE Conference on Computer Vision and Pattern Recognition, 4264-4271.
Zhou Z, Hong X, Zhao G & Pietikäinen M (2014) A compact representation of visual speech data using latent variables. IEEE Transactions on Pattern Analysis and Machine Intelligence 36(1):181-187.

The following publications include teachings of computer-vision based face and body analysis techniques which teachings are hereby incorporated by reference in their entirety:
A. Pease, B. Pease, The definitive book of body language. Peace International, Peace International, 2004.
C. Darwin, P. Prodger, The expression of the emotions in man and animals, Oxford University Press, USA, 1998.
P. Ekman, F. Wallace, Facial Action Coding System: A Technique for the Measurement of Facial Movement, Consulting Psychologist Press, 1978.
K. Brow, Kinesics. Encyclopedia of Language and Linguistics 2nd Edition, Elsevier Science, 2005.
B. Pease, A. Pease, The definitive book of body language, Bantam, 2004.
D. Rosenstein, H. Oster, Differential facial responses to four basic tastes in newborns, Child development (1988) 1555-1568.
P. Ekman, W. V. Friesen, M. O'sullivan, A. Chan, I. DiacoyanniTarlatzis, K. Heider, R. Krause, W. A. LeCompte, T. Pitcairn, P. E. Ricci-Bitti, et al., Universals and cultural differences in the judgments of facial expressions of emotion., Journal of personality and social psychology 53 (4) (1987) 712.
B. d. Gelder, Why Bodies? Twelve Reasons for Including Bodily Expressions in Affective Neuroscience., hilosophical Transactions of the Royal Society B: Biological Sciences 364 (364) (2009) 3475-3484.
A Kleinsmith, N. Bianchi-Berthouze, Affective body expression perception and recognition: A survey, TAC 4 (1) (2013) 15-33.
M. Karg, A.-A. Samadani, R. Gorbet, K. Kühnlenz, J. Hoey, D. Kuli\acute{ }c, Body movements for affective expression: A survey of automatic recognition and generation, TAC 4 (4) (2013) 341-359.
C. A. Corneanu, M. O. Simon, J. F. Cohn, S. E. Guerrero, Survey on rgb, 3d, thermal, and multimodal approaches for facial expression recognition: History, trends, and affect-related applications, IEEE transactions on pattern analysis and machine intelligence 38 (8) (2016) 1548-1568.
S. Escalera, V. Athitsos, I. Guyon, Challenges in multi-modal gesture recognition, in: Gesture Recognition, Springer, 2017, pp. 1-60.
M. Asadi-Aghbolaghi, A. Clapés, M. Bellantonio, H. J. Escalante, V. Ponce-López, X. Baró, I. Guyon, S. Kasaei, S. Escalera, Deep learning for action and gesture recognition in image sequences: A survey, in: Gesture Recognition, Springer, 2017, pp. 539-578.
J. F. laccino, Left brain-right brain differences: Inquiries, evidence, and new approaches, Psychology Press, 2014.
H. Ruthrof, The body in language, Bloomsbury Publishing, 2015.
P. Molchanov, S. Gupta, K. Kim, J Kautz, Hand gesture recognition with 3d convolutional neural networks, in: Proceedings of the IEEE conference on computer vision and pattern recognition workshops, 2015, pp. 1-7.
A. Pease, B. Pease, The Definitive Book of Body Language: how to read others' attitudes by their gestures, Hachette UK, 2016.
A. W. Siegman, S. Feldstein, Nonverbal behavior and communication, Psychology Press, 2014.
H. Gunes, M. Piccardi, Fusing face and body gesture for machine recognition of emotions, in: Robot and Human Interactive Communication, 2005. ROMAN 2005. IEEE International Workshop on, IEEE, 2005, pp. 306-311.
H. Gunes, M. Piccardi, A bimodal face and body gesture database for automatic analysis of human nonverbal affective behavior, in: Pattern Recognition, 2006. ICPR 2006. 18th International Conference on, Vol. 1, IEEE, 2006, pp. 1148-1153.
H. Gunes, C. Shan, S. Chen, Y. Tian, Bodily expression for automatic affect recognition, Emotion recognition: A pattern analysis approach (2015) 343-377.
D. Efron, Gesture and environment. [24] A. Kendon, The study of gesture: Some remarks on its history, in: Semiotics 1981, Springer, 1983, pp. 153-164.
Dimension of body language, http://westsidetoastmasters. com/resources/book_of_body_language/toc.html/, [Online; accessed 19 Jun. 2017].
P. Ekman, An argument for basic emotions, Cognition & emotion 6 (3-4) (1992) 169-200.
L. A. Camras, H. Oster, J. J. Campos, K. Miyake, D. Bradshaw, Japanese and american infants' responses to arm restraint., Developmental Psychology 28 (4) (1992) 578.
https://www.udemy.com/body-language-basics-in-business-world, accessed: Dec. 15, 2017.
C. Frank, Stand Out and Succeed: Discover Your Passion, Accelerate Your Career and Become Recession-Proof, Nero, 2015.
R. W. Simon, L. E. Nath, Gender and emotion in the united states: Do men and women differ in self-reports of feelings and expressive behavior?, American journal of sociology 109 (5) (2004) 1137-1176.
U. Hess, S. Senécal, G. Kirouac, P. Herrera, P. Philippot, R. E. Kleck, Emotional expressivity in men and women: Stereotypes and self-perceptions, Cognition & Emotion 14 (5) (2000) 609-642.
D. Bernhardt, Emotion inference from human body motion, Ph.D. thesis, University of Cambridge (2010).
T.-y. Wu, C.-c. Lian, J. Y.-j. Hsu, Joint recognition of multiple concurrent activities using factorial conditional random fields, in: Proc. 22nd Conf. on Artificial Intelligence (AAAI-2007), 2007.
M. A. Fischler, R. A. Elschlager, The representation and matching of pictorial structures, IEEE Transactions on computers 100 (1) (1973) 67-92.
T. Tung, T. Matsuyama, Human motion tracking using a colorbased particle filter driven by optical flow, in: The 1st International Workshop on Machine Learning for Vision-based Motion Analysis-MLVMA'08, 2008.
P. F. Felzenszwalb, D. McAllester, Object detection grammars , in: ICCV Workshops, 2011, p. 691.
W. Zhang, J. Shen, G. Liu, Y. Yu, A latent clothing attribute approach for human pose estimation, in: Asian Conference on Computer Vision, Springer, 2014, pp. 146-161
Y. Baveye, E. Dellandrea, C. Chamaret, L. Chen, Liris-accede: A video database for affective content analysis, TAC 6 (1) (2015) 43-55.
W. Li, Z. Zhang, Z. Liu, Action recognition based on a bag of 3d points, in: CVPRW, 2010, pp. 9-14.
I. Humaine, Human-machine interaction network on emotion, 2004-2007 (2008).
S. Z. Masood, C. Ellis, A. Nagaraja, M. F. Tappen, J. J. LaViola, R. Sukthankar, Measuring and reducing observational latency when recognizing actions, in: ICCVW, 2011, pp. 422-429.
J. Shotton, T. Sharp, A. Kipman, A. Fitzgibbon, M. Finocchio, A. Blake, M. Cook, R. Moore, Real-time human pose recognition in parts from single depth images, Communications of the ACM 56 (1) (2013) 116-124.
H. Ranganathan, S. Chakraborty, S. Panchanathan, Multimodal emotion recognition using deep learning architectures, in: 2016 IEEE Winter Conference on Applications of Computer Vision (WACV), IEEE, 2016, pp. 1-9.
S. Fothergill, H. Mentis, P. Kohli, S. Nowozin, Instructing people for training gestural interactive systems, in: Proceedings of the SIGCHI Conference on Human Factors in Computing Systems, ACM, 2012, pp. 1737-1746.
Face and Body Gesture Recognition for a Vision-Based Multimodal Analyzer Hatice Gunes, Massimo Piccardi, Tony Jan Computer Vision Research Group, University of Technology, Sydney (UTS) (http://crpit.scem.westernsydney.edu.au/confpapers/CRPITV36Gunes.pdf).
Survey on Emotional Body Gesture Recognition Fatemeh Noroozi, Ciprian Adrian Corneanu, Dorota Kaminska, Tomasz Sapi\acute{ }nski, Sergio Escalera, \acute{ } and Gholamreza Anbarjafari, (https://arxiv.org/pdf/1801.07481.pdf).
C. Ellis, S. Z. Masood, M. F. Tappen, J. J. LaViola, R. Sukthankar, Exploring the trade-off between accuracy and observational latency in action recognition, International Journal of Computer Vision 101 (3) (2013) 420-436.
H. Chauhan, A. Chauhan, Implementation of decision tree algorithm c4. 5, International Journal of Scientific and Research Publications 3 (10).

The following publications include teachings of machine (e.g. neural network) based techniques for speech analysis which teachings are hereby incorporated by reference in their entirety:
Comparison of Neural Network Models for Speech Emotion Recognition, 2018 2nd International Conference on Data Science and Business Analytics (ICDSBA) (21-23 Sep. 2018), Added to IEEE Xplore: 27 Dec. 2018 INSPEC Accession Number: 18366576, DOI:10.1109/ICDSBA.2018.00030.

A scene monitoring and guidance system, according to embodiments of the present invention, may be integral or otherwise connected to one or more (scene) sensors directed towards a scene of interest, such as at a scene, venue, or location where an interaction or meeting of interest is or will take place. An interaction or meeting of interest according to embodiments, may be classified as being of a specific interaction/meeting type, such as for example a “sales” type of interaction, a “service request” type of interaction or a “complaint resolution” type of interaction, just to name of few types. A scene where specific interaction types are staged, organized or otherwise occur may be referred to as a scene of a specific scene type, such as for example a “sales” type scene, a “service request” type scene and/or a “complaint” type of scene.

Scene related sensors according to embodiments of the present invention may include cameras, audio sensors, temperature sensors, humidity sensors, air pressure sensors, biometric sensors (e.g. heart rate, body temp, respiration, eye movement and pupil dilation) and/or any other sensors which may be relevant to monitoring an interaction between two more scene participants. External condition sensors or data feeds may also be received and or otherwise monitored in accordance with some embodiments of the present invention.

Sensor outputs may be monitored and or analyzed for purposes of detecting messages and or message responses within interactions between scene participants in a monitored scene. Message detection and classification may be at least partially based on processing of the sensor outputs using message detection parameters within a scene/interaction type configuration script for the given scene/interaction type. Response detection and classification may be at least partially based on processing of the sensor outputs using response detection parameters within a scene/interaction type configuration script for the given scene type.

A given scene/interaction, according to embodiments, may be further associated with, or its interaction script may include, an interaction objection. A first interaction participant message may be assessed—for its impact on a second participant—at least partially based on an analysis of the second participant response message, and/or his behavioral response, to that message. Second participant responses' indications of advancement towards, or away from, the objective, may be used to characterize the impact of the first participant message.

A step by step analysis, of multiple interaction message-response pairs or sets, may be accordingly utilized to assess the impact of a sequence of interaction messages and generate/select participant guidance and/or intervention to direct the interaction's course in a path, possibly one of multiple possible ones, towards the aspired objection associated with the interaction.

According to some embodiments, an interaction type configuration script may be automatically generated at least partially based on a system received or retrieved commercial and/or regulatory compliance protocol or policy, wherein the regulatory compliance protocol may for example relate to a financial, legal, public, institutional, governmental, organizational or other in-person interaction, in which an agent participant is obliged/requested to specific interaction rules and/or actions.

Interaction factors and features contributing to and/or needed for compliance with a specific protocol (or, for example dispute prevention), may be identified and analyzed based on parameters of the compliance configuration script associated with the specific protocol. Factors and features may for example include: specific declarations or statements the agent participant should make; specific reminders the agent should give to the other subject/guest/customer participant; specific forms, documents, payments or items that should be presented or exchanged; specific actions that should take place such as, signings, blessings, escorting, receiving authorizations, exceeding time frames and others.

A compliance protocol based interaction type configuration script, utilized by the system, may monitor, facilitate, and contribute to compliance, for example by: (1) Improving new-comer and annual compliance training; (2) Engaging and incentivizing staff in self and team-compliance; (3) Responding in near real-time to potential or actual compliance breaches; and/or (4) Strengthening the company by mitigating compliance violations.

Embodiments of the present invention may also include participant interface/notification/intervention devices or appliances which signal or otherwise convey a scene guidance instruction to one or more scene participants. Scene guidance instructions may be real-time and may be conveyed to one or more scene participants in response to either a static trigger or to a dynamic trigger. An example of a static trigger may be the passing of a specific duration of time since an interaction started. An example of a dynamic trigger may be the detection of specific messages and/or specific responses exchanged during an interaction.

A computerized system operating in accordance with embodiments of the present invention may generate one or more scene guidance instructions automatically, in response to a detection of a specific condition of an interaction within a scene of a given scene type. The condition may be at least partially associated with specific content or messages exchanged between two or more people in the scene. The condition may be at least partially with specific responses to content or messages exchanged between two or more participants in the scene. The detected message or response relating to the condition may be verbal, non-verbal, physical, biometric, etc. The detected condition may also relate to environmental conditions within and otherwise related to the monitored scene.

Detection of a scene/interaction related condition, either participant or environment related, by a system operating in accordance to embodiments of the present invention may include sensor or data feed monitoring and classifying performed in accordance with parameters or code provided by a configuration script. Each scene or interaction type may be associated with a different configuration script. The configuration script according to embodiments may include specific instructions (e.g. code, algorithms, Neural Network structures, etc.) for detecting and or extracting specific content from within specific sensor outputs. A configuration script according to embodiments may also include specific instructions (e.g. code, algorithms, Neural Network structures, etc.) for detecting specific content (messages or responses) from within a combination of sensor outputs of differing formats.

Notification and interface devices or appliances according to embodiments of the present invention may signal or otherwise convey real-time scene guidance instructions to non-participants in the scene or its vicinity, for example to an assistant or to a manager of one of the participants in the scene. Real-time scene guidance instructions to non-participants in the scene may initiate or instruct an external intervention in the scene for which the instruction was generated.

According to some embodiments, any of the analysis, conclusion-reaching, and intervention methods, techniques and systems described herein, may be based on information acquired from the monitoring of a computer mediated interaction between two or more participants, present at the same scene or at two or more different scenes.

According to some embodiments, monitored scene analysis, report, recommendation and intervention, as described herein, may be based on any combination of scene sensors output data; and data derived from the monitoring of computerized devices and/or applications installed/running thereon, used by the interaction participants to interact.

In the following descriptions, various features of a system in accordance with embodiments of the present invention are exemplified. The following non-limiting definitions and terms are utilized, as part of describing system features, components, interconnections and implemented methods.

Definitions:

Host—an organization that uses the system and employs people that conduct meetings under monitoring.
Agent—a participant in the meeting on behalf of the host.
Guest—the other participant/party that takes part in the meeting.
Venue/Scene—a physical place where the meeting is conducted.
Secretary—a member of the host who sits out of the meeting room and serves the meeting.
Sensors—physical devices in the venue that collect information in several dimensions during the meeting.
System—the invention system as described herein.
Conclusion—any observation, instruction or message that the system generates during or after the meeting based on fusing and analyzing the output of the sensors.
Respond-able event—an event that occurs during a meeting session, to which the organization has a regular response

According to some embodiments, an exemplary system implemented method of extracting conclusions from a face-to-face meeting between an agent and a guest, may comprise sensing, fusing and analyzing a plurality of sensors monitoring the venue/scene of the meeting. The exemplary system implemented method may further include reaching specific analysis based conclusions and executing meeting venue/scene interventions based thereof and/or associated therewith.

(I) According to some embodiments, various sensors and sensor types may monitor the venue/scene of the meeting or interaction for generating meeting venue/scene data for processing by the system's analysis modules. Sensors, according to embodiments, may include any combination of the following sensor types and configurations:

(A) Simple Sensors

(1) Audio—a microphone or a set of microphones, optionally configured in an array form to allow for acoustic beam forming, designed to capture and separate between the guest voice(s) and the agent voice(s), for example by use of distributed, directional microphones and/or by acoustic beam forming. Additionally, software/logic for analysis of the content (NLP) and parameters of the voices.

(2) Video—One or more video cameras—for example a triplet of cameras located to capture the agent's body, the guest's body and the desktop between them in a good viewing angle and resolution. Video camera(s) may include or be functionally associated with a tracking logic to lock on and track the agent and/or guest within the monitored venue/scene as they move and change their location.

(3) Room climate—Sensors that measure simple climate parameters such as temperature, humidity, light, noise etc. The system may interface with one or more ambient condition altering devices (e.g. AC, lights, background music player) to automatically optimize the conditions in the venue/scene, for reaching a successful meeting outcome, at least partially based on acquired climate parameters. Optimized conditions may, for example, be based on climate parameters records of prior successful meetings of the same venue/scene/meeting type.

(4) Background noises—one or more microphones that pick up external noises that penetrate the meeting venue/scene. This microphone(s) may for example take the form of a contact microphone against a window or a wall.

(B) Complex Sensors

(1) Agent bio-parameter signals—One or more body sensors, wearable device sensors and/or venue/scene sensors may capture and record agent's bio-signals during meeting interactions, for monitoring and training purposes. Captured and recorded signals may for example include heartbeat rate, respiration rate, sweating/conductivity, eye blinking, gaze direction and/or any other measurable bio-parameter of the agent(s) and optionally the guest(s) and/or any other scene subject. Sensors, in accordance with some embodiments, may be positioned or hidden at a meeting venue/scene location undetectable by the guest.

(2) Guest bio-signals (known to guest)—A set of sensors may be embedded in the meeting venue/scene room/space, for example in the chair of both guest and agent, to monitor bio-parameters of both parties. The signals may be mutually recorded in the meeting log and can be made available to both parties. Sensors may be embedded in chair for measuring, for example: heartbeat rate, respiration rate, leg swinging and/or other bio-parameters.

(3) Guest bio-signals (unknown to guest)—Utilizing guest undetectable bio-parameter sensors to derive guest related parameters such as: truth saying, integrity, honesty and the like, optionally by utilizing third party covert polygraph methodologies and systems (e.g. Dan Atlas's technology for covert polygraph).

(4) Guest eye tracking—The system may apply an eye-tracking device that tracks the gaze of the guest. For mutuality—it may be adapted to also track and record the gaze of the agent as well. Software/logic may correlate eye-movement with the context of the meeting (e.g. current speaker) to detect guest distraction, boredom, fear, micro-expressions and/or any other sentiment type.

(5) Agent invisible keypad—The system may offer the agent an invisible keyboard, or other physical or virtual input device, that may be operated at a hidden location (e.g. under the meeting desk with one hand). This functionality may serve the agent to covertly enter meeting information that may substitute, or be considered/analyzed in conjunction with, sensor data based records, conclusions and/or cues.

(6) Guest pupil size—The system may extract guest's pupil opening size/diameter from within meeting video data and interpret it in the context of the meeting (Source—Shmuel Ur) (e.g. current speaker) to detect guest distraction, boredom, fear, micro-expressions and/or any other sentiment type.

(7) Guest facial expressions—The system may analyze the guest's facial expressions and classify them into pre-defined categories in the context of the meeting (source—Shmuel Ur) (e.g. current speaker) to detect guest distraction, boredom, fear, micro-expressions and/or any other sentiment type.

(8) Guests speech intonation—The system may analyze the speech intonation of the guest and classify it by pre-defined reference classes such as: relaxed, enthusiastic, sad, happy, surprised, threatening and/or any other sentiment/mood/characteristic. These attributes may be factored as part of the analysis of the meeting.

(9) Guest body language—The system may analyze guest body language and classify it by pre-defined reference classes such as: impatience, nervousness, sympathizing, antagonistic and/or any other sentiment/mood/characteristic. These attributes may be factored as part of the analysis of the meeting.

(II) According to some embodiments, various monitored scene related conclusions may be reached by the system's analysis modules based on sensors collected interaction/meeting data. Conclusions, according to embodiments, may include real-time feedbacks provided to the agent, that may include any combination of the following feedback types:

(1) Tips and instructions based on guest response—The system may have access to a list of detectable utterances and gestures that indicate, with good probability, certain feelings and dispositions. The system may detect and interpret the utterances and gestures. The system may relay and present notifications including statements of these feelings—for example, as a clear message on the agent's device screen, wherein the message may be invisible to the guest. The system may retrieve/pull from a database tips—corresponding to types of feelings detected—provided by the host to guide the agent on how to react to these feelings.

(2) Agent alert on deviation from script—The system may follow the progress of the interaction/conversation according to a prescribed script. When the system detects significant deviation of the agent from the script, it may create a brief alert and present it on the agent's device screen. A NLP engine may be utilized to decide if a deviation from a script justifies an alert (e.g. with minimum false positives and false negatives) for example, based on the calculation of a semantic distance between the prescribed script and a detected utterance or gesture.

(3) Presenting Guest profile to host—When the identity of the guest is known to the system, the system may generate or receive a profile of the guest, the system presents the guest profile to the agent so the agent can make use of it when addressing the guest.

(4) Recommendation on background music and room climate—The system may derive a recommended environment for a given meeting, based on the guest profile and/or the meeting purpose. The environment recommendations may relate to: temperature, humidity, lighting, type and volume of music and/or any other scene environment aspect or parameter. The agent device application may be utilized to override the system's decision or recommendation and otherwise adjust the environment, in order to make the meeting most productive.

(5) Guidance to shorten/extend meeting according to outside/external pressures on the process—For example, an assumption that the meeting will be more productive for the host when it is longer. The agent cannot know if he may extend the meeting as he does not know the load of the guest(s). The system may provide the agent, by a message on his device screen, an indication on an outside (e.g. guests) load, thus enabling him to tune the length of the meeting if a received system message indicates that the guest is in no pressure to leave.

According to some embodiments, various monitored scene related conclusions may be reached by the system's analysis modules based on sensors collected interaction/meeting data. Conclusions, according to embodiments, may include off-line or retrospective observations of the meeting (e.g. for the host), provided to the agent, may include any combination of the following observation types:

(A) Observations of Agent Performance.

(1) Script compliance—The system may grade the compliance of the agent with the script of the meeting and logs deviations, for example: skipping script steps, deviations of attention, and/or too long or too short sections. The system may then process multiple meeting sessions for each agent, and provide the agent and or the host with a summary and/or rank of the level of compliance with the script.

(2) Allocation of agent training sessions—The system may include, or have access to, a database/repository of training content (e.g. books, video clips, consulting sessions). Upon detection of a repetitive deviation of an agent from a script, the system may use a look-up/reference table to recommend one or more of the database/repository training sessions associated with the detected repetitive agent deviation, to that agent.

(3) Agent manners—The system may include, or have access to, a database/repository of typical human gestures/wordings/sounds that are considered bad manners, for example: picking one's nose, scratching one's crotch, coughing without a covering arm, cursing, and/or raising the voice. Such gestures/wordings/sounds may be detected by the system through comparison of monitored meeting acquired data to the reference gestures/wordings/sounds records.

(4) Agent assertiveness—The system may monitor the statements of the agent and the reaction of the guest and apply an algorithm/logic that scores the assertiveness of the agent's utterances—by assessing the understanding and the acceptance of the utterance by the guest. The system may then calculate a score(s) for the level of assertiveness of the agent during the meeting.

(5) Agent appearance—A dedicated algorithm/logic of a video analytics system module may scan the agent and recognize visual features relevant to his proper appearance according to a predefined list of features. Exemplary agent appearance features may include a combination of: clean shirt, proper tie, proper haircut, proper combing, proper shaving and/or avoidance of undesired gestures such as picking the nose or ear. The system may then calculate an appearance score(s) for the agent based on the detection of such appearance faults.

(6) Agent sensitivity to guest body language—A dedicated algorithm/logic of a video analytics system module may scan the agent may detect body language gestures of the guest, and monitor the response by the agent. Cases where a body language gesture of the guest is not responded to by the agent, are recorded.

(7) Relevance of agent reaction to guest inputs—The system may detect and interpret—by video analytics and/or by NLP—gestures and utterances of the guest that invite a real-time response by the agent, while monitoring the agent to detect instances of poor or absent reaction of the agent to such gestures and utterances. A report on such observations may be generated, and presented on agent device and/or communicated to the host.

(8) Monitoring guest satisfaction during meeting—The system may use indications of satisfaction by the guest, such as smiles, head nodding, supportive utterances and/or relaxed posture and monitor the evolution of guest's satisfaction during the meeting. The system may assess and report the level of satisfaction, an average satisfaction, detected positive and negative peaks of satisfaction, and present them in real-time and/or as an off-line summary to the agent or to the host.

(B) Conclusions and Recommendation for Host Management

(1) Adjustments to current scripts—The system may accumulate repetitive faults of the above described types and may correlate them with the type of script and with the identity of the agent. Correlation of repetitive faults with a specific type of script, persisting across different agents, may trigger an automatic update of the script and/or a notification being sent and presented to the host—optionally suggesting modifications to the script to address the identified repetitive faults.

(2) Need of new scripts—repetitive faults, detected by the system or indicated by the agent, for example in meetings that do not have a binding script, may be presented to the host as an invitation to create a script designed to reduce the frequency of the faults.

(3) Corrections of choice of venue/scene—repetitive faults, or complaints by agent and/or by guest, that will show statistical correlation with a specific venue/scene (e.g. coffee shop meetings, large empty conference room meetings, open space meetings, in-vehicle meetings) as well as instances of success that will show correlation with a specific venue/scene, may be suggested to the host as preferable venues over other venues for that type of meetings.

(4) Tactical intelligence derived from session (prices, competitors, suppliers)—The system may detect—based directly on sensors data and/or on cues from the agent—utterances of the guest that carry tactical intelligence for the organization about competitors, competing products, competing prices etc. Detected intelligence information may be indexed and recorded

(5) Strategic intelligence extracted from session—as described above for Tactical intelligence derived and/or based thereof.

(6) Leads extracted from session—The system may accumulate raw leads for additional business. The leads may be detected automatically by an NLP engine detecting names of potential customers and attractive products, and/or may be cued by the agent using a dedicated cue phrase.

(7) Selection of optimal agent for a given meeting—The system may profile potential meetings, using profiles of available agents and profiles of expected guests, to determine the expected success of each agent in each scheduled meeting (a combination of guest and meeting type) and advise on a preferred agent for a planned meeting. Parameters for correlation may for example include a combination of: languages, gender, age, type of humor, common hobbies, common place of living, common marital state, common age of children or grandchildren and/or records of prior agent-guest successful meeting.

(C) Transaction Records

(1) Sales transaction records—The system may support the agent in generating formal transactions such as sales, returns, enquiries etc. by seeking the values to fill in a digital form, within the utterances that the agent and the guest make. The system may then output the fully or partially filled records for the agent to check, complete and authorize.

(2) Deliveries—Meeting related deliveries may be monitored, detected and logged by the system to generate and provide agent support and/or for future reference or analysis of the meeting.

(3) Cash transactions—The system may detect and follow a transfer of cash between the agent and the guest, may recognize the bills and count them, and automatically generate a statement of the amount transferred, optionally adding video clip tags as a retrievable certificate—a receipt.

(4) Agent or Guest commitment records—The system may detect agent and guest commitments made during a meeting, for example based on NLP engine identification of specific language associated with the verbal making of a commitment (e.g. ‘I will make transfer tomorrow’, ‘50 units will be supplied this month’). Gestures, for example a hand shake between agent and guest may also be monitored and utilized as commitment-associated events.

(5) Agent or Guest wish records—The system may detect agent and guest wishes made during a meeting, for example based on NLP engine identification of specific language associated with the verbal making of a wish or aspiration (e.g. ‘I really like this product’ [would like to buy it], ‘It is a bit expensive’ [would like a small discount]). Gestures, for example an agent or guest putting his palms together in front of his chest or looking upwards may also be monitored and utilized as wish-associated events.

(6) Generation of 3rd party messages—The system may detect and register meeting utterances indicating a meeting related task or role for execution or follow up by/with a third party. The system may generate a listing of third party messages, and/or automatically compile and relay such messages, based on meeting detected third party names/aliases and related role or task mentioned.

(7) Mapping guest profile—The system may fuse inputs from all venue/scene sensors, optionally including inputs of a form/report filled by the agent at the end of the meeting, to generate/update a guest profile.

(8) Mapping agent profile—The system may integrate inputs from all sensors, from a period of meetings across several guests, to derive a profile of the agent. Elements in the profile may for example include a combination of: average and deviation of meeting length, average amount of guest complaints, average transactions created in the meetings, usage of system tools for enhancement of meetings and/or others.

(III) According to some embodiments, various monitored venue/scene related interventions may be triggered/executed by the system's intervention modules based on sensors collected interaction/meeting data analysis, agent cues and/or additional factors. Interventions, according to embodiments, may include the selection and triggering of actions, occurrences and/or ambient conditions changes at the venue/scene of the meeting, based on one, or a combination of, conditions/cues being detected at and/or received from the monitored venue/scene meeting/interaction. Intervention triggers and actions may include any combination of the following types:

(A) Agent Initiated Interventions

(1) Cues

(i) Spoken clauses—The system may reference a set of pre-defined utterances that are interpreted as cues. Specific utterances that are not likely to be uttered by the agent accidentally, such as “Let me state this right now” or “Let me grab a piece of paper”, may be automatically selected and presented to the agent prior to and/or during a meeting. At least some of the cues may trigger interventions, as described herein. Some cues may trigger an intervention indicating to the agent that the previous utterance(s) should be interpreted in a specific context (e.g. last sentence of guest was a commitment). Some cues may trigger an intervention indicating to the agent that the next utterances should be interpreted in a specific context (e.g. next sentence that I will say should be sent as voice WhatsApp to my secretary).

(ii) Gestures—The system may reference a set of pre-defined gestures that are interpreted as cues. Specific gestures that are not likely to be made by the agent accidentally, such as ‘putting both hands behind the back-head’, ‘pulling a pen out of the pocket and putting it back in immediately’, may be automatically selected and presented to the agent prior to and/or during a meeting.

(iii) Physical switch—The system may include ‘invisible’ switches/devices/interfaces that may be easily accessed by the agent activate, to trigger the communication of specific intervention(s) request. For example, the activation of, or receipt of specific input from, a physical or virtual (e.g. projected) switch, keyboard, knob and/or any other machine interface element—may be interpreted as a cue.

(2) Cue Interpretations

(i)—A system implemented “cherry-basket” method for cue interpretation, in accordance with embodiments, may include copying a last/next segment of the sensor signals to a “cherry” basket for off line interpretation. Two or more cues categories may be defined—one for “previous” and one for “forthcoming” cues. The system may be provided with, or automatically generate, information indicating how far back is the “previous” cue, and how far forward is the “forthcoming” cue—for post-meeting/off-line reference of the basket by the agent, to facilitate direct/indexed access and meeting-context-association of ques, eliminating the need for a serial/manual scan/listening/viewing by the agent, of entire meeting data segments.

(ii) Signals for guest capture—The agent may trigger a system generated signal that will be naturally sensed by the guest, in order to check (e.g. visually, through the sensors) the guest's reaction to the signal. The system triggered signal may be generated directly by the system and/or by one or more signal generating devices functionally-associated and/or networked with the system. Signals may, for example, take the form of: a loud sound, a flash of light, an item falling from a shelf, a phone ring, a fire alarm, an insect released from a cage, a release of an odor to the room atmosphere and/or any other biologically or technologically sensible signal.

(iii) Pulling agent out of meeting—The system may enable the agent to initiate an “unexpected” event that will “force” him to leave the meeting for a short while or permanently. The system mechanism may, upon the agent initiating a trigger, send a notification to generate (e.g. to human secretary) a popping message on the screen saying “pull me out for 5 minutes now”. The secretary may then knock on the door and interrupt the meeting with an urgent context dependent message such as “the boss needs you for 5 minutes now”.

Alternatively, the agent may want for the closed door of his office to be opened (e.g. so that the guest will know that people may listen to the conversation). In such a case the system generated message that will pop for the secretary may be “I am opening your door as I must step out for 5 minutes, kindly make sure nobody comes near my desk”.

(iv) Entrance of 3rd party with agenda—The system may, based on an agent cue interpreted, trigger the sending of a notification/message/summon to a specific 3rd party (e.g. agent manager, agent secretary, an actor with a specific role) to enter the meeting venue/scene (e.g. office room) with some casual reason, in order to witness a part of the meeting.

For example, the guest has negotiated an important deal and seems to be ready to close it, with parameters (e.g. price, delivery time, specifications) that are beyond the authority of the agent. The agent may not want to lose the momentum of the meeting by postponing the response to another time. He may also not want to show the guest that he does not have sufficient authority. The agent can cue-trigger a cure that will pop a message—for example on the secretary's screen of on the manager's screen/mobile—asking them to pop into the meeting with some excuse. When this solicited interruption happens, the agent may casually describe the situation to the manager, and the manager can exercise his higher authority to close the deal in real time.

(v) Peace-breaking interrupt—Specific agent cues may be interpreted to trigger a staged alarm or emergency event (e.g. power down, fire alarm, explosion), for example, in order for an agent to prevent a severe meeting outcome he is predicting or has received a system prediction/indication of.

(vi) Adjustment of room climate—The agent may initiate a change in the room climate if he feels, or receives a system prediction, that it may serve the goal of the meeting. The change may for example be designed to make the guest feel more comfortable (to extend his visit) or less comfortable (to shorten his visit). The parameters may for example include: temperature, humidity, lighting, and/or an external noise level.

A system selected climate changing cue, according to embodiments, may be a cue ‘invisible’ to the guest (e.g. a common gesture repeated, or performed in specific manner) and/or may be binary—having two possible outcomes—such as “add 2 degrees to temperature” or “gradually dim 5% of the light”. System selected or generated cues may be communicated and presented to the agent prior to, or during, a monitored meeting.

(vii) Preventing cellular communication—The meeting venue/scene/room may be equipped with communication gear for preventing/blocking/jamming cellular reception and communication and/or any other communication network (e. g. Wi-Fi, Bluetooth), wherein the operation of the communication gear may be turned on or off by a cue of the agent. The agent may want to block external distraction of the guest (see U.S. Pat. No. 6,456,822—Electronic device and method for blocking cellular communication). The system may be functionally associated with the communication gear, to trigger its operation—and thus enable or disable cellular/other communication in the venue/scene/room—based on specific agent cue(s) detected.

(viii) Soliciting a paper note to agent—The agent may want to appear receiving an urgent paper note during the meeting. An agent cue may pop up a message on a work colleague's (e.g. the secretary's) screen to bring him a folded note into the meeting venue/scene/room and hand it to him. The agent may then look at the note and carry on the meeting, at a system suggested course and/or at least partially based on a received system instruction, as if it is influenced by what he read in the note.

(ix) External call to guest—The system may initiate a false/staged call to the guest's mobile device—based on a specific agent cue detected. Such a call may teach the agent information about the character of the guest, may distract the guest's attention from an uncomfortable line of the conversation and/or may give the agent an excuse to divert his own attention for a moment—to his phone, his screen or his notes.

(x) Generation of messages to 3rd party—Based on an agent cue, the system may access a database/repository of previously prepared (e.g. by agent) messages and select an auto voice call message, a text message and/or a video massage, for communication to specific people in the host organization. The agent may trigger the selection of such a message and its sending, in response to a specific pre-defined cue he performed. Specific messages may be pre-associated, and then selected and send, with specific corresponding agent cues.

For example, the message may serve a legitimate surveillance task, instructing the gate keeper of the parking garage—go to the parking guest's car and take a note of the stuff on the back seat, the display/meter readings and/or whether there are passengers in the car waiting for the guest. Another example can be a message to the concierge at the lobby, to take note in which direction will the guest be going when he leaves the building. Another exemplary message may be to the workshop, telling the manager to ask the secretary for the name of the guest and to quickly prepare a dedicated give-away with inscription of the quest's name and rush it to the secretary, so that the guest will feel that the gift was prepared for him in advance.

(xi) Mapping a profile of guest—The agent may want, for example in order to map a profile of the guest, to collect sensor signals not collected default and/or at non-default time points/segments. The system may accumulate and analyze such additional signals from the system sensors in response to detection of specific corresponding cues made by the agent.

(B) Guest Initiated Interventions

(1) Complaints—The system may detect, in the guest's, expressions of dissatisfaction and complaints. The agent may not be sensitive to them, or may even have an inclination to ignore or deny such expressions. The system may compare the agent's report/records of the meeting against guest's authentic expressions of dissatisfaction and complaints, as expressed in the detected utterances, gestures and/or body languages.

(2) Requests—The system may detect, in the guest's, expressions of requests, wills and/or aspirations. The agent may not be sensitive to them, or may even have an inclination to ignore or deny such expressions. The system may compare the agent's report/records of the meeting against guest's authentic expressions of requests, wills and/or aspirations, as expressed in the detected utterances, gestures and/or body languages.

(C) Host Initiated Interventions

(1) 3rd party entering the room—the system may be configured to detect, in real time, extreme events that require intervention of a third party without the initiation of the agent (see “cues”). Such intervention may be necessary if the conversation/interaction between the agent and the guest approaches a risk of violence, compromising critical host values, apparent illegal transactions, or the like. If the system detects such circumstances it can automatically trigger an alert or a notification to a manager. A system manger-interface may present/play/display to the manager in substantially real-time—and optionally in accordance with ethics, regulations and host policy records/schemes—sensors acquired meeting data. The manager interface may further present a request for the manager to step into the meeting, notify a third party to intervene, and/or send a notification to the agent to come out of meeting venue/scene for explanations.

(2) Session checklist monitor—The system may present—on a screen or other output component of the agent device/interface—a host compiled checklist pre-associated with the meeting type of the session. The check-list may list items/tasks that the agent should cover/execute in the conversation/interaction. During the session, the system may check (mark) items/tasks that have been covered/executed, as soon as the NLP/Video-Analysis modules detects and reports that they have been covered/executed. The agent may be presented with a status of items/tasks already covered/executed and may manually check items/tasks that he has covered/executed onto the presented check list, optionally having the ability to override system unrecognized item/tasks that were covered/executed. The presented check-list may initiate agent reminders of the items/tasks left to be covered/executed in the meeting session, optionally at specific times during the meeting, recognized by the system as optimal.

(3) Prescribed responses to session respond-able events—The system may detect events that happen during the meeting session and are tagged for nominal response. Exemplary events may include: guest mentions transportation difficulty, guest mentions a son in the army, guest mentions elderly parents, guest mentions a relocation plan and/or other. In case a respond-able event is detected, the system may present/display to the agent the detected event and optionally the expected/recommended response—such as the steps that agent should follow.

(IV) According to some embodiments, various monitored venue/scene recordings/data-acquisitions may be executed in accordance with a covert or overt system recording/data-acquisition protocol or scheme.

(1) Covert recording—If the circumstances allow covert recording, without cooperation or notification of the guest—the system may execute the recording based on a covert recording protocol.

(2) Overt recording—If covert recording of the guest is not politically acceptable, not legal in the circumstances, or not desired for business considerations, the system may execute the recording based on an overt recording protocol. An overt recording protocol may implement a symmetric and mutual recording/data-acquisition, serving both parties at the same time. The recording system protocol may be symmetrical between the agent and the guest. It may include two separate on-off switches or interface elements, one controlled by the agent and one controlled by the guest. Recording may take place only if both switches/elements are “on”.

The raw recording (multidimensional signals) may be copied into a storage media that is given, or accessible, to the guest for his own records. The recording may accordingly become a symmetrical action serving both parties and may be utilized to encourage the guest to consent to the recording. The data may be stored such that the agent and/or the host have access to advanced analytic algorithms on the raw recording, but the guest may also extract whatever information he needs from his copy/accessing of the recording.

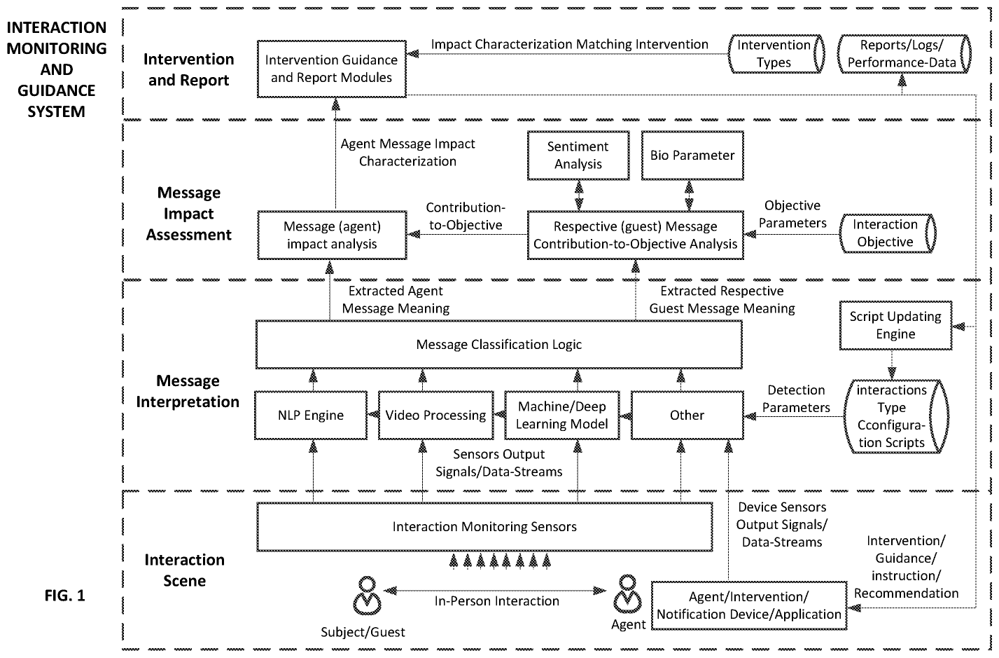

Reference is now made to FIG. 1, where there is shown a block diagram of an exemplary system for generating a scene guidance instruction, in accordance with some embodiments of the present invention, wherein main system components and interrelations there between are shown.

In the exemplary figure, there are shown interaction monitoring sensors monitoring an in-person interaction between an agent and a subject/guest. An agent device/application is shown to provide further interaction data acquired by the device's sensors. Sensor output signals/data-streams from the scene of interaction are relayed/communicated to a computing/cloud-computing platform where agent and subject/guest messages are interpreted.

A Natural Language Processing (NLP) engine, a video processing engine, a machine/deep learning analysis model and other optional interaction data processing modules are shown—for extracting interaction messages meaning based on processing and analysis results. Processing and analysis—for example, the type of interaction features searched for, detected and interpreted—is configured based on detection parameters of a database stored interaction type configuration script, associated with the type of interaction being monitored.

A message classification/source-detection logic, analyzes extracted messages meaning and features to associate messages with either the agent or the subject/guest.

An extracted agent message meaning and an extracted meaning of a respective subject/guest following/reply message are relayed for impact assessment. The impact of the agent's message on the subject/guest is characterized based on analysis of the respective subject/guest message for indications of contribution towards, or away from, an objective (e.g. agent's, agent's organization) of the interaction. Sentiment analysis and Bio-Parameter analysis are shown as optional ‘respective message’ analysis tools that may indicate contribution direction (i.e. towards/away) from the objective and/or or its level, for example, a positive sentiment with normal pulse may indicate subject/guest inclination towards agreeing to the agent's prior message's offering, a step towards the objective—a sale.

The intervention guidance and report modules shown, based on the agent message impact characterization, references/selects and triggers corresponding scene interventions and/or agent guidance, instructions, or recommendations. Interaction logs, performance assessments and generated reports are stored for future reference, agent training and performance analysis purposes. Updates may be made to the interaction type configuration script database records, based on monitored interaction analysis and assessment results.

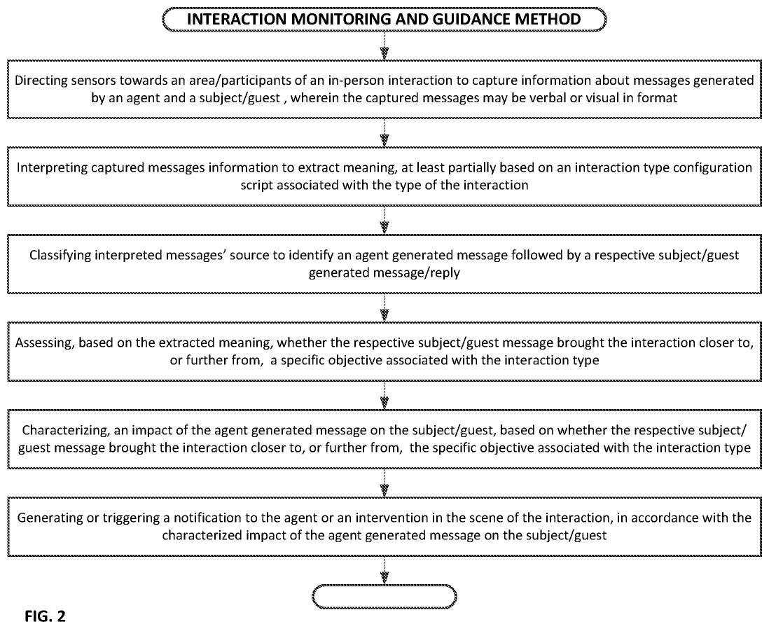

Reference is now made to FIG. 2, where there is shown a flowchart of the main steps executed as part of an exemplary process for monitoring a scene interaction and generating a scene guidance instruction, in accordance with some embodiments of the present invention.

Exemplary process steps shown, include: (1) Directing sensors towards an area/participants of an in-person interaction to capture information about messages generated by an agent and a subject/guest, wherein the captured messages may be verbal or visual in format; (2) Interpreting captured messages information to extract meaning, at least partially based on an interaction type configuration script associated with the type of the interaction; (3) Classifying interpreted messages' source to identify an agent generated message followed by a respective subject/guest generated message/reply; (4) Assessing, based on the extracted meaning, whether the respective subject/guest message brought the interaction closer to, or further from, a specific objective associated with the interaction type; (5) Characterizing, an impact of the agent generated message on the subject/guest, based on whether the respective subject/guest message brought the interaction closer to, or further from, the specific objective associated with the interaction type; and (6) Generating or triggering a notification to the agent or an intervention in the scene of the interaction, in accordance with the characterized impact of the agent generated message on the subject/guest.

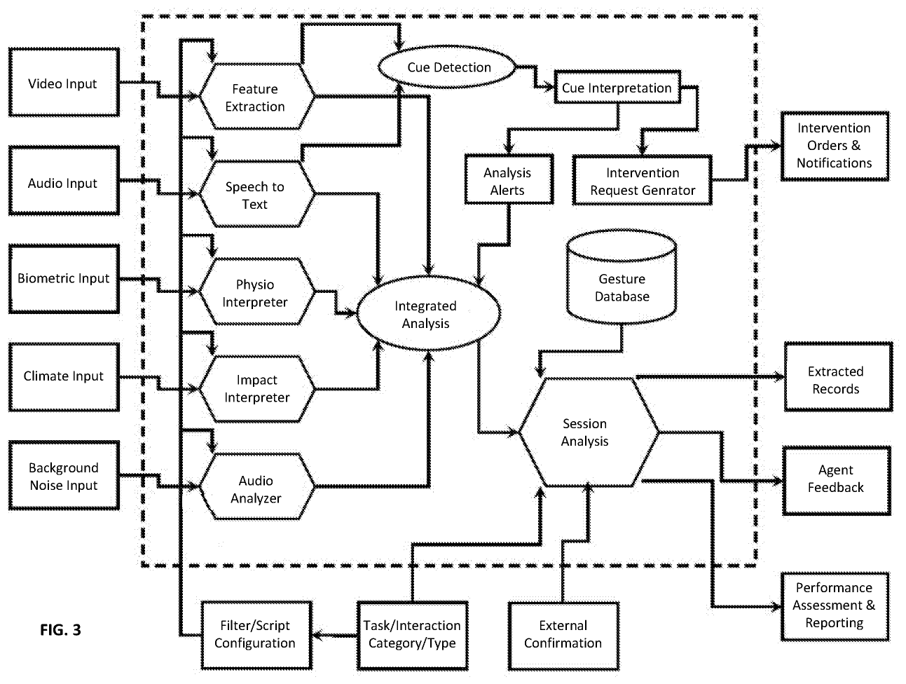

Reference is now made to FIG. 3, where there is shown a block diagram of an exemplary system for generating a scene guidance instruction, in accordance with some embodiments of the present invention, wherein data input, processing, analysis and output components of the system and data flow there between are shown.

In the figure, interaction monitoring sensors': video input, audio input, biometric input, climate input and background noise input; are respectively processed by: a feature extractor, a speech to text engine, a physio-interpreter, an impact interpreter and an audio analyzer. Processing is performed in accordance with an interaction type filter/script configuration.

Processing results, along with cue detection and interpretation based analysis alerts (e.g. detected agent cue effecting analysis), are relayed for integrated analysis of the multiple processed inputs.

Integrated analysis results are utilized—along with the session/interaction type, reference data such as the shown gesture database and optionally based on an external confirmation—for session/interaction analysis execution, including: records extraction, agent feedback (real-time or retrospective) and performance assessment and reporting.

Interaction cues detected and interpreted, trigger the generation of corresponding intervention requests for intervention orders and notifications to be issued.

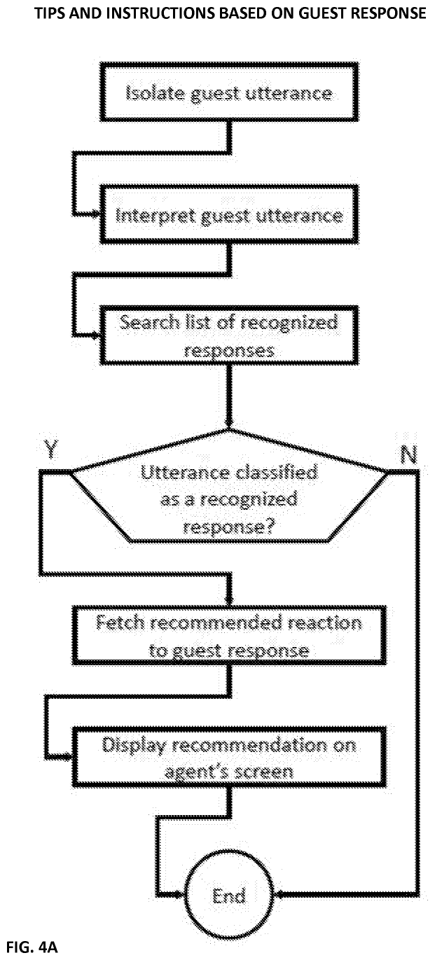

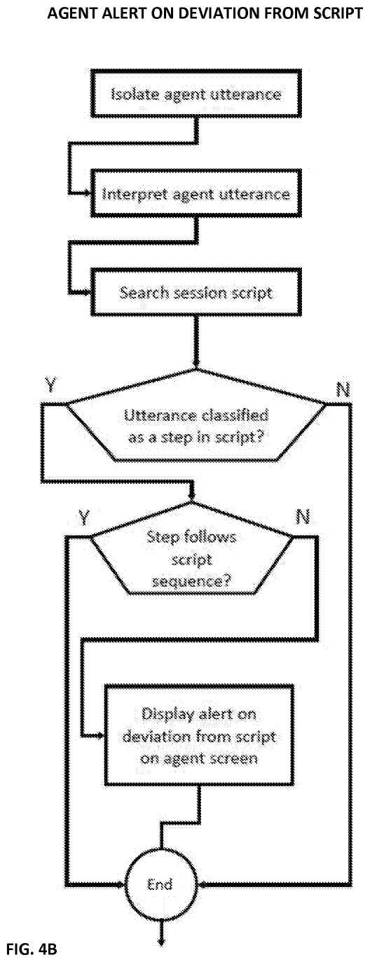

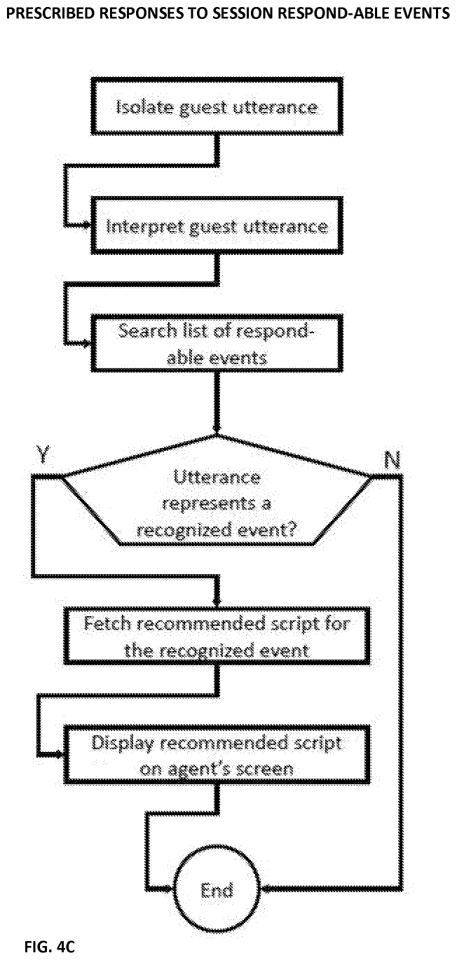

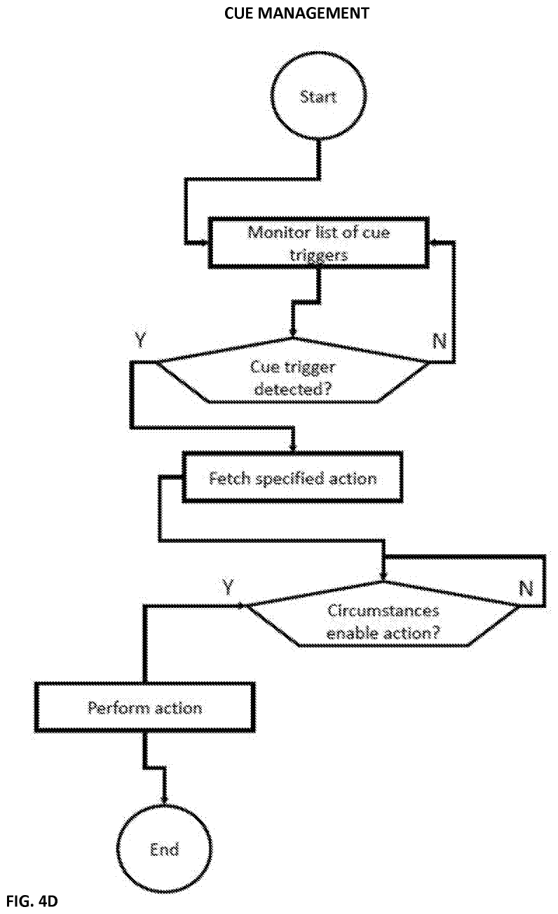

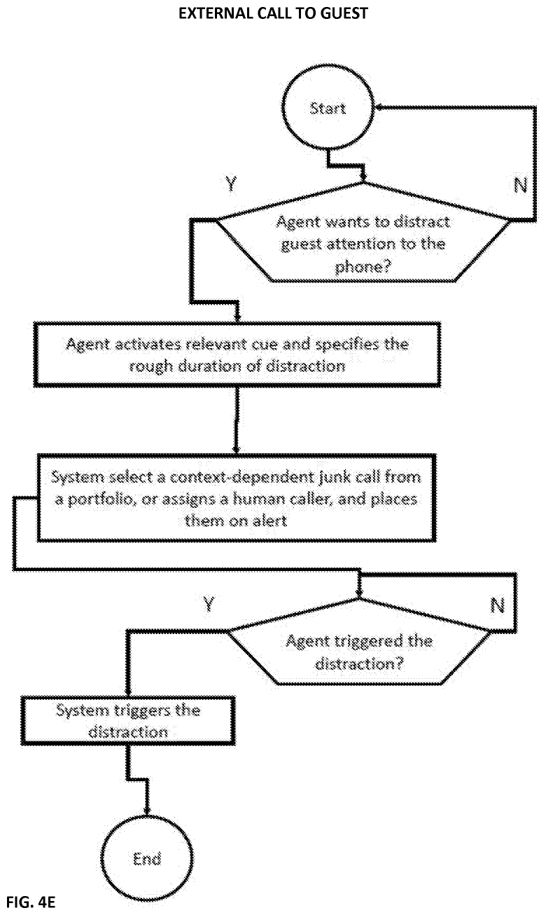

Reference is now made to FIG. 4A, where there is shown a flowchart of the main steps executed as part of an exemplary process for generating instructions based on a guest response, in accordance with some embodiments of the present invention.

Exemplary process steps shown, include: (1) Isolate guest utterance; (2) Interpret guest utterance; (3) search list of recognized responses; (4) If utterance is classified as recognized response then: (5) Fetch recommended reaction to guest response, (6) Display recommendation on agent's screen and (7) End; Else (7) End.

Reference is now made to FIG. 4B, where there is shown a flowchart of the main steps executed as part of an exemplary process for generating an alert on deviation from a monitored scene or meeting script, in accordance with some embodiments of the present invention.

Exemplary process steps shown, include: (1) Isolate agent utterance; (2) Interpret agent utterance; (3) Search session/interaction script; (4) If utterance is classified as a step in the script then (5) If step follows script sequence then (7) End, else (6) Display alert of deviation from script on agent's screen; Else, If utterance is not classified as a step in the script, then (7) End.

Reference is now made to FIG. 4C, where there is shown a flowchart of the main steps executed as part of an exemplary process for generating responses to session respond-able events, in accordance with some embodiments of the present invention.

Exemplary process steps shown, include: (1) Isolate guest utterance; (2) Interpret guest utterance; (3) search list of respond-able events; (4) If utterance represents a recognized event, then: (5) Fetch recommended script for the recognized event, (6) Display recommended script on agent's screen and (7) End; Else (7) End.

Reference is now made to FIG. 4D, where there is shown a flowchart of the main steps executed as part of an exemplary process for cue management, in accordance with some embodiments of the present invention.

Exemplary process steps shown, include: (1) Monitor list of que triggers; (2) If que trigger not detected return to (1), if que trigger detected (3) Fetch specified action; (4) Repetitively check if circumstances enable action, once answer is positive (5) perform action; and (6) End.

Reference is now made to FIG. 4E, where there is shown a flowchart of the main steps executed as part of an exemplary process for initiating an automatic call to guest participant in a monitored scene meeting or interaction, in accordance with some embodiments of the present invention.

Exemplary process steps shown, include: (1) Repetitively check if agent wants to distract guest attention to the phone, once answer is positive (2) Receive relevant cue activated by agent and specification of the rough duration of distraction; (3) Select a context dependent junk call from a portfolio, or assign/notify human caller; (4) Repetitively check if agent triggered the distraction, once answer is positive (5) Trigger the distraction; and (6) End.

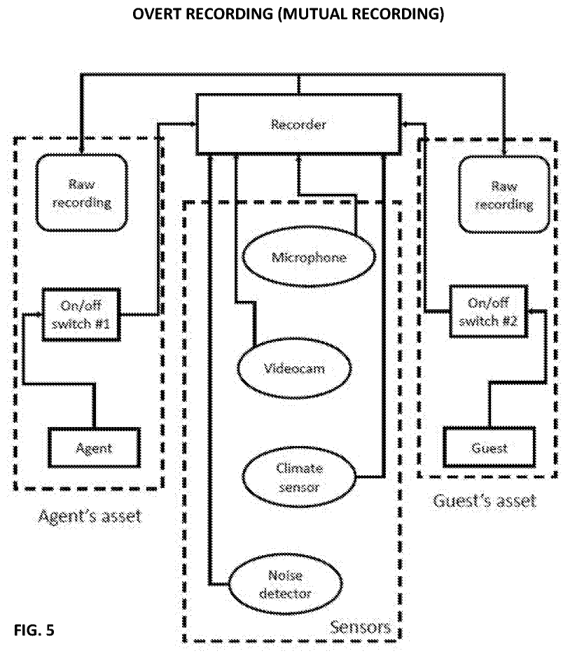

Reference is now made to FIG. 5, where there is shown a schematic layout showing the main components and data/signals flows of an exemplary mutual recording configuration/scheme of a system in accordance with some embodiments of the present invention.

In the figure there are shown: a microphone, a video camera, a climate sensor and a noise detector, providing interaction inputs to a mutual (agent and guest) recorder. The recorder only initiates and maintains its operation when both, the agent's switch #1 and the guest's switch #2, are in an ‘on’ position, upon which raw recording data from the mutual recorder is relayed, logged, presented and/or made available to the parties. Accordingly, both sides may be at liberty to halt the mutual recording—and thus prevent the collection/access of interaction records—without need for action or authorization from the other participant.

According to some embodiments of the present invention, a system for assessment of an in-person interaction between a subject and an agent having a specific objective for the interaction, may comprise: (1) One or more sensors directed towards an area of the interaction and adapted to capture information about messages generated by the agent and the subject, wherein the captured messages can be verbal or visual in format; (2) a computing platform to receive and process the captured information using: (a) a computerized message interpreter adapted to extract meaning from the captured messages information; and (b) a message impact assessment module to characterize, based on the extracted meaning, an impact of each agent generated message on the subject, wherein each impact characterization indicates whether a respective message brought the interaction closer to, or further from, the specific objective.

According to some embodiments, the computer platform may further include a message classification logic for classifying, based on the extracted meaning, a specific interaction message, as expressed by either the agent or subject interacting.

According to some embodiments, extracting meaning from the captured messages may be at least partially based on processing of the sensor outputs using detection parameters within an interaction type configuration script for the given interaction.

According to some embodiments, the computing platform may further comprise an interaction intervention module for generating an interaction agent instruction corresponding, and in response, to specific impact characterizations of one or more consecutive agent generated messages on the subject.

According to some embodiments, the system may further include one or more agent devices or appliances to signal, present or otherwise convey, substantially in real-time, an interaction agent instruction communicated by the interaction intervention module.

According to some embodiments, the interaction type configuration script may be automatically generated at least partially based on a system received or retrieved regulatory compliance protocol.

According to some embodiments, the impact characterization indicating whether the respective message brought the interaction closer to, or further from, the specific objective, may at least partially factor an interest level of the subject in the agent generated message which triggered the respective message.

According to some embodiments, the impact characterization indicating whether the respective message brought the interaction closer to, or further from, the specific objective, may at least partially factor an estimation of the subject's sentiment towards the agent generated message which triggered the respective message.

According to some embodiments, characterization of the impact of each agent generated message on the subject, may be at least partially based on the reference of a deep learning model, trained with agent generated messages data from previous interactions, sharing the same interaction type configuration script, in which the specific objective has been reached.

According to some embodiments, characterization of the impact of each agent generated message on the subject, may be at least partially based on comparison of the meaning extracted from the agent message to meanings extracted from agent generated messages data from previous interactions, sharing the same interaction type configuration script, in which the specific objective has been reached.

According to some embodiments of the present invention, a method for assessment of an in-person interaction between a subject and an agent having a specific objective for the interaction, may comprise: (1) capturing, using sensors, information about messages generated by the agent and the subject, wherein the captured messages can be verbal or visual in format; (2) extracting meaning from the captured messages information; and (3) characterizing, based on the extracted meaning, an impact of each agent generated message on the subject, wherein each impact characterization indicates whether a respective message brought the interaction closer to, or further from, the specific objective.

According to some embodiments, the method may further comprise classifying, based on the extracted meaning, a specific interaction message, as expressed by either the agent or subject interacting.

According to some embodiments, extracting meaning from the captured messages may include processing of the sensor outputs using detection parameters within an interaction type configuration script for the given interaction.

According to some embodiments, the method may further comprise generating an interaction agent instruction corresponding, and in response, to specific impact characterizations of one or more consecutive agent generated messages on the subject.

According to some embodiments, the method may further comprise signaling, presenting or otherwise conveying, substantially in real-time, a generated interaction agent instruction.

According to some embodiments, the method may further comprise automatically generating the interaction type configuration script at least partially based on a system received or retrieved regulatory compliance protocol.

According to some embodiments, the method may further comprise factoring an interest level of the subject in the agent generated message as part of agent message characterization.

According to some embodiments, the method may further comprise factoring an estimation of the subject's sentiment towards the agent generated message as part of agent message characterization.

According to some embodiments, the method may further comprise referencing a deep learning model, trained with agent generated messages data from previous interactions, sharing the same interaction type configuration script, in which the specific interaction objective has been reached.

According to some embodiments, the method may further comprise comparing of the meaning extracted from the agent message to meanings extracted from agent generated messages data from previous interactions, sharing the same interaction type configuration script, in which the specific interaction objective has been reached.

The subject matter described above is provided by way of illustration only and should not be constructed as limiting. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A system for assessment of an in-person interaction between a subject and an agent having a specific objective for said interaction, wherein said system comprises:
one or more sensors directed towards an area of the interaction and adapted to capture information about messages generated by the agent and the subject, wherein the captured messages can be verbal or visual in format;
a computing platform to receive and process the captured information using:
a computerized message interpreter adapted to extract meaning from the captured messages information; and
a message impact assessment module to characterize, based on the extracted meaning, an impact of each agent generated message on the subject, wherein each impact characterization indicates whether a respective message brought the interaction closer to, or further from, the specific objective.

2. The system according to claim 1, wherein said computer platform further includes a message classification logic for classifying, based on the extracted meaning, a specific interaction message, as expressed by either the agent or subject interacting.

3. The system according to claim 1, wherein extracting meaning from the captured messages is at least partially based on processing of said sensor outputs using detection parameters within an interaction type configuration script for the given interaction.

4. The system according to claim 3, wherein said computing platform further comprises an interaction intervention module for generating an interaction agent instruction corresponding, and in response, to specific impact characterizations of one or more consecutive agent generated messages on the subject.

5. The system according to claim 4, wherein said system further includes one or more agent devices or appliances to signal, present or otherwise convey, substantially in real-time, an interaction agent instruction communicated by said interaction intervention module.

6. The system according to claim 3, wherein the interaction type configuration script is automatically generated at least partially based on a system received or retrieved regulatory compliance protocol.

7. The system according to claim 1, wherein the impact characterization indicating whether the respective message brought the interaction closer to, or further from, the specific objective, at least partially factors an interest level of the subject in the agent generated message which triggered the respective message.

8. The system according to claim 1, wherein the impact characterization indicating whether the respective message brought the interaction closer to, or further from, the specific objective, at least partially factors an estimation of the subject's sentiment towards the agent generated message which triggered the respective message.

9. The system according to claim 3, wherein characterization of the impact of each agent generated message on the subject, is at least partially based on the reference of a deep learning model, trained with agent generated messages data from previous interactions, sharing the same interaction type configuration script, in which the specific objective has been reached.

10. The system according to claim 3, wherein characterization of the impact of each agent generated message on the subject, is at least partially based on comparison of the meaning extracted from the agent message to meanings extracted from agent generated messages data from previous interactions, sharing the same interaction type configuration script, in which the specific objective has been reached.

11. A method for assessment of an in-person interaction between a subject and an agent having a specific objective for said interaction, said method comprising:
capturing, using sensors, information about messages generated by the agent and the subject, wherein the captured messages can be verbal or visual in format;
extracting meaning from the captured messages information; and
characterizing, based on the extracted meaning, an impact of each agent generated message on the subject, wherein each impact characterization indicates whether a respective message brought the interaction closer to, or further from, the specific objective.

12. The method according to claim 11, further comprising classifying, based on the extracted meaning, a specific interaction message, as expressed by either the agent or subject interacting.

13. The method according to claim 11, wherein extracting meaning from the captured messages includes processing of the sensor outputs using detection parameters within an interaction type configuration script for the given interaction.

14. The method according to claim 13, further comprising generating an interaction agent instruction corresponding, and in response, to specific impact characterizations of one or more consecutive agent generated messages on the subject.

15. The method according to claim 14, further comprising signaling, presenting or otherwise conveying, substantially in real-time, a generated interaction agent instruction.

16. The method according to claim 13, further comprising automatically generating the interaction type configuration script at least partially based on a system received or retrieved regulatory compliance protocol.

17. The method according to claim 11, further comprising factoring an interest level of the subject in the agent generated message as part of agent message characterization.

18. The method according to claim 11, further comprising factoring an estimation of the subject's sentiment towards the agent generated message as part of agent message characterization.

19. The method according to claim 13, further comprising referencing a deep learning model, trained with agent generated messages data from previous interactions, sharing the same interaction type configuration script, in which the specific interaction objective has been reached.

20. The method according to claim 13, further comprising comparing of the meaning extracted from the agent message to meanings extracted from agent generated messages data from previous interactions, sharing the same interaction type configuration script, in which the specific interaction objective has been reached.
